(19) United States
(12) Patent Application Publication
(10) Pub. No.: US 2014/0355395 A1
(43) Pub. Date: Dec. 4, 2014

(54) ANTIFRICTION COATING FOR MAINSPRING MADE OF COMPOSITE MATERIAL

(71) Applicant: Cartier Creation Studio SA, Geneva (CH)

(72) Inventors: Christophe Avril, Foucherant (FR); Dominique Perreux, Pirey (FR); Jean-Michel Tisserand, Choissey (FR)

(21) Appl. No.: 14/361,238

(22) PCT Filed: Nov. 30, 2012
(86) PCT No.: PCT/EP2012/074139

§ 371 Date: May 28, 2014

(30) Foreign Application Priority Data
Dec. 9, 2011 (EP) 11192835.4

(51) Int. Cl. G04B 1/14

(52) U.S. Cl. CPC G04B 1/145
USPC 368/141; 427/372.2

(57) ABSTRACT

Mainspring for driving a clock movement, said mainspring being made of a material comprising a polymer matrix containing fibres, said mainspring having a coating containing a thermoset or thermoplastic polymer. The mainspring proposed reduces the friction of the turns of the mainspring.

### CROSS-REFERENCE TO RELATED APPLICATIONS

This application is a National Phase of PCT Application No. PCT/EP2012/074139, filed Nov. 30, 2012, which claims the benefit of European Application No. 11192835, filed Dec. 9, 2011. The entire contents of those applications are hereby incorporated by reference.

### TECHNICAL FIELD

The present invention relates to a coated mainspring for a driving element in a mechanical timepiece movement. The coating makes it possible to reduce the rubbing actions of the coils of the spring and has good cohesion.

### STATE OF THE ART

The barrel spiral mainspring is the element which makes it possible to store the mechanical energy necessary for the operation of the watch. Generally, its geometrical dimensions and the mechanical properties of the material of which it is composed determine the potential energy which the spiral mainspring is capable of storing and the maximum torque which it delivers. The unwinding of the ribbon of the spring produces the energy necessary for the operation of the watch. FIG. 1 shows an exploded view of a mainspring 1 housed in a barrel drum 2. The shape of the ribbon of the spring has evolved into a shape recognized as inverted S (see FIG. 2 and “Théorie d'horlogerie” [Theory of Horology] by C-A Reymondin et al., published by the Federation des Ecoles Techniques [Federation of Technical Schools], Switzerland, 1998). This specific shape makes it possible to produce a torque which is relatively constant, whatever the state of winding of the spring. The maximum energy is stored by the mainspring when the proportion between the surface area occupied by the latter, when it is wound, and that which remains free in the drum is approximately 50%.

Timepiece manufacturers have sought from time immemorial to increase the energy storage capacity of the mainsprings and thus the power reserve of mechanical watches, without, however, increasing the volume, that is to say the bulkiness, of the barrels. Efforts have mainly been directed at reducing the energy losses, in particular those due to rubbing actions. Thus it is that the proposal has been made to coat the mainspring with a lubricating layer, for example a coating of metal or of DLC (Diamond-Like Carbon), in order to limit the internal rubbing actions.

However, the coating of the spring has to put up with several constraints. On the one hand, it has to participate in decreasing the friction between the coils and, on the other hand, it has to participate in the overall cohesion of the material of the spring. However, between the wound and unwound positions, the surface of the spring is subjected to very great deformations. In the case of the abovementioned coatings, repetition of such deformations, during the winding and unwinding of the spring, can result in the coating breaking or delaminating. For the same reasons, a coating, the elastic behavior of which is provided by bonds of covalent or ionic type, such as a coating made of ceramic or diamond, also cannot ensure satisfactory cohesion of the coating with the spring.

### BRIEF SUMMARY OF THE INVENTION

A subject matter of the present invention consists of the provision of a mainspring for a driving element for a timepiece movement, said mainspring being made of a material comprising a polymer matrix comprising fibers, said mainspring comprising a coating comprising a thermosetting or thermoplastic polymer; the coating having a thickness at least equal to a quarter of the width of a fiber of said fibers.

Another subject matter of the invention consists of the provision of a driving element for a timepiece movement comprising said mainspring.

Yet another subject matter of the invention consists of the provision of a timepiece comprising the driving element.

Yet another subject matter of the invention consists of a process for producing the mainspring, comprising the steps of:
providing the mainspring made of a material comprising a polymer matrix comprising fibers;
coating the mainspring (1) with a composition comprising a polymer;
homogenizing the thickness of the composition coating the mainspring; and
polymerizing the composition in order to form the coating.

In one embodiment, coating the mainspring can comprise a step of immersion of the spring in the composition, or a step of spray coating, or a step of vapor-phase deposition.

The mainspring provided makes it possible to reduce the rubbing actions of the coils of the mainspring and the coating has good cohesion.

### BRIEF DESCRIPTION OF THE FIGURES

Examples of embodiments the invention are shown in the description, which are illustrated by the appended figures, in which:

FIG. 1 shows an exploded view of a mainspring housed in a barrel drum;

FIG. 2 illustrates the inverted S shape of the ribbon of the mainspring; and

FIG. 3 shows a cross section of the mainspring, according to one embodiment.

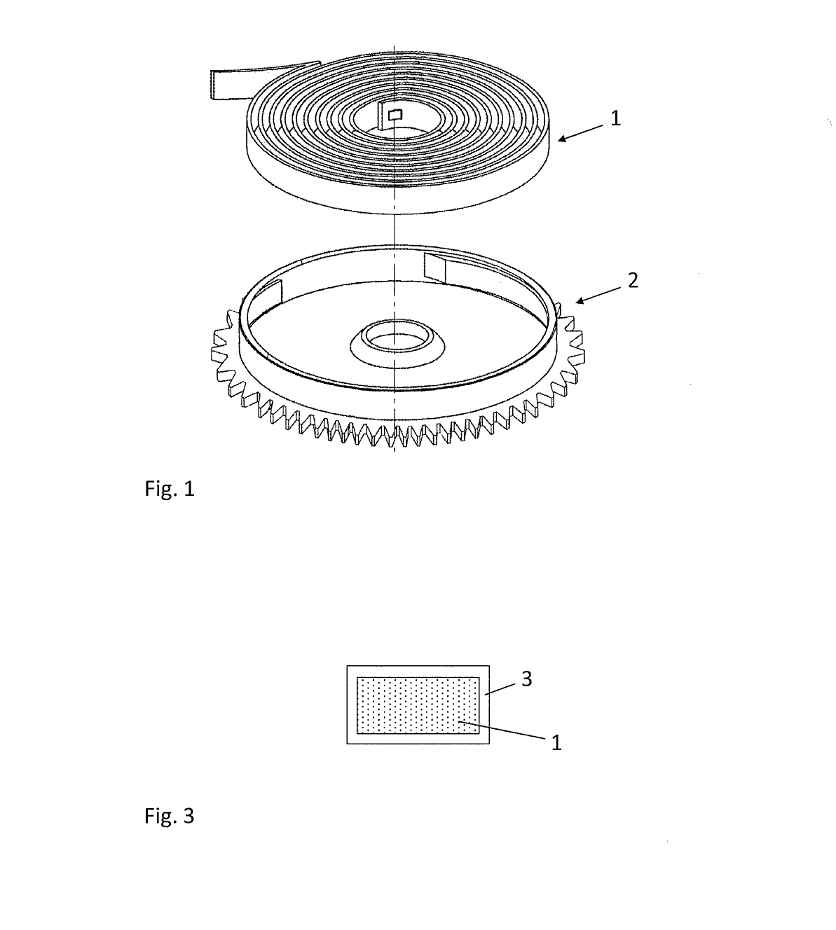

### DETAILED DESCRIPTION OF POSSIBLE EMBODIMENTS OF THE INVENTION

In one embodiment, a mainspring 1 is manufactured from a composite material. The term “composite material” is understood here to mean a polymer matrix comprising fibers, such as glass fibers or other fibers. Preferably, the fibers are oriented unidirectionally in the polymer matrix. Such springs manufactured from the composite material may be less susceptible than conventional metal springs to fatigue fractures and consequently may have a longer lifetime.

The fibers of such a composite spring can be made of carbon, of glass or of aramid or may also be of another nature (for example mixtures of fibers) but, in all cases, their axial elasticity modulus is preferably between 80 GPa and 600 GPa. The fibers generally have the same length as the spring and are positioned as parallel as possible to the main length of the spring. Preferably, the angle between the axis of each fiber and the axis of the spring is as close as possible to 0° and does not locally exceed 5°. The fibers typically have a diameter of between 1 μm and 35 μm. A single spring can have fibers of different diameters but, preferably, the diameters used in the thickness of the spring make it possible to place at least ten fibers side by side in order to obtain a mainspring having a better homogeneity.

The polymer matrix can comprise a thermoplastic or a thermosetting plastic. The fraction by volume of fibers in the polymer is preferably between 30% and 75% or also between 45% and 55%. Nanoparticles can be added to the polymer matrix so as to harden the latter in order to push back the microbuckling of the fibers in the face in compression of the spring in flexion. These nanoparticles can be silica, fullerenes or any other material having the possibility of bonding to the polymer resin and of increasing the compressive strength thereof, without reducing the ability of the polymer resin to bond to the fibers.

A polymer matrix reinforced with unidirectional glass fibers exhibits an elasticity modulus approximately from four to five times lower than that of steel for an elastic limit lower by approximately half. Everything otherwise being equal in the geometry of a steel spring or of a composite spring: same length, same thickness and same width, will result in the composite spring having a recoverable stored elastic energy level at least equal, often slightly greater than, that of the steel spring and a lower variation in the torque delivered as a function of the barrel rotation, this variation being proportionally related to the inverse of the Young's modulus of the material. On the other hand, the maximum torque level possible will be lower for the composite spring with respect to the steel spring, this maximum torque being proportional to the breaking stress of the material. Preferably, the polymer matrix comprises an epoxy resin and the fibers are type E glass fibers or type S or type S2 glass fibers. The properties of these glass fibers are given in table 1.

TABLE 1

| Fibers | Glass E | Glass S or S2 |
|---|---|---|
| Elasticity modulus, at | 70 (+/−2) | 88 (+/−2) |
| 20° C. | GPa | GPa |
| Breaking stress, at | 3620 (+/−170) | 4980 (+/−150) |
| 20° C. | MPa | MPa |

The composite mainspring 1 can be manufactured by mixing fibers and the polymer matrix in the liquid state in a form of a strip. The mainspring can also be manufactured by using a prepreg material in which the fibers and the polymer matrix are already mixed and in which the polymerization reaction is halted by a chemical retarder. The fibers are preferably aligned along the greatest length of the strip. The strip is subsequently wound up in a mold while exerting a tension along the length, which makes it possible to wind up the composite strip. The composite is subsequently polymerized, for example by external pressure of approximately 10 bar, so that the composite is forced to remain in the mold and indeed takes the shape thereof. After curing, the composite is removed from the mold and the surface of the mainspring thus formed is polished in order to remove the imperfections related to the manufacturing process.

The composite mainspring 1 is advantageously coated with an antifriction coating 3 (see FIG. 3), so as to reduce the rubbing actions between the coils of the spring 1 when the latter is fitted into the barrel. FIG. 3 shows a cross section of the mainspring 1 comprising said coating 3. In the case of a spring made of epoxy resin reinforced with type S glass fibers, the deformations discussed above can be greater than 3% in tension, respectively −3% in compression. The coating 3 should thus be able to provide satisfactory cohesion under these conditions.

In one embodiment, the coating 3 comprises a material, the bonds of which are of hydrogen bond or Van der Waals type. More particularly, the spring is coated with a coating comprising a thermosetting or thermoplastic polymer. Preferably, the coating comprises a resin of epoxy type having slow polymerization, that is to say having a gel time which is greater than 20 min at 90° C.

In one embodiment, a process for producing the mainspring 1 comprising the coating 3 comprises the steps of:
providing the mainspring 1 made of a material comprising a polymer matrix comprising the fibers;
coating the mainspring 1 with a composition comprising a polymer;
homogenizing the thickness of the composition coating the mainspring 1 in order to equalize the thickness of the composition at the surface of the mainspring 1; and polymerizing the composition in order to form the coating 3.

The composition can be prepared by mixing a curing agent, the polymer and a catalyst, under ambient conditions (ambient temperature and pressure). The composition is heated to a temperature of between 35° C. and 70°, so as to render the composition sufficiently fluid, that is to say until the composition has a critical viscosity of less than 3000 mPa.s and preferably of less than 300 mPa.s. Coating the mainspring 1 can comprise completely immersing the spring in the composition for an immersion time typically of between 5 and 20 seconds. After the immersion step, the composition is still in a relatively liquid form. The compatibility between the composition and the epoxy resin forming the matrix of the spring results in good wettability of the composition at the surface of the spring. Preferably, the polymer of the composition is a resin of epoxy type. Alternatively, coating the mainspring 1 can comprise a step of spray coating or also a step of vapor-phase deposition. In the latter case, the polymer of the composition is preferably a Parylene polymer.

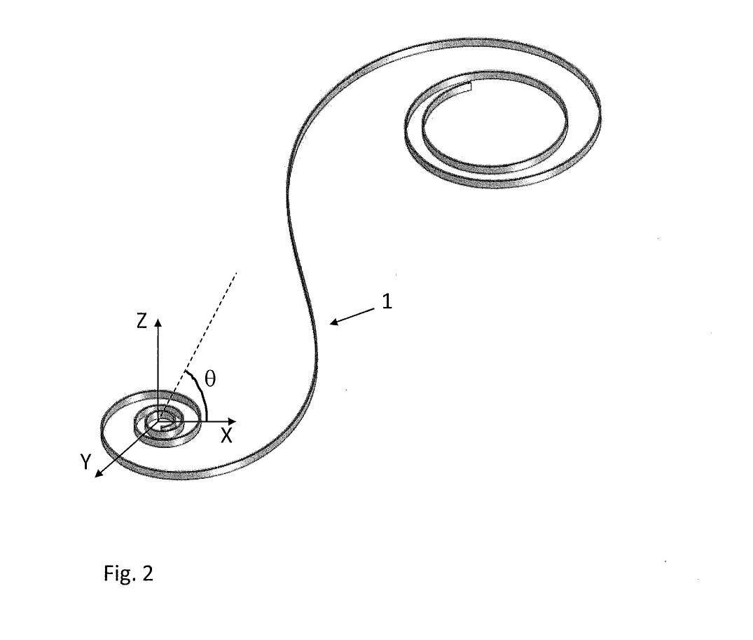

In one embodiment, the homogenization step comprises the rotation of the mainspring coated with the composition along axes of rotation oriented in the three orthogonal dimensions X, Y and Z (see FIG. 2). To this end, the spring can be held by its two ends, for example, using a pair of small clamps (not represented). The two ends of the spring can be rendered integral with one another via a metal rod or a plate (which are also not represented). The rotation of the spring is carried out so as to take advantage of gravity, which acts on the still fluid composition. The rotation can be carried out at a rotational speed of between 5 rev/min and 60 rev/min, and preferably between 10 rev/min and 30 rev/min. According to an alternative form, the rotation of the mainspring coated with the composition is carried out along a single axis of rotation oriented with an angle of between 10° and 80° from the plane of winding of the mainspring. The homogenization step is carried out until the composition is polymerized, thus forming the coating.

The step of polymerization of the composition can comprise the heating of the mainspring 1 coated with the composition. The heating can be carried out by placing the mainspring 1 in an oven or also by providing infrared or microwave radiation. The heating is preferably carried out during the homogenization step. The heating can also comprise a gradual increase in the temperature until the temperature of polymerization of the composition is reached.

In order to obtain a polymer matrix comprising fibers which makes possible a reduction in the rubbing actions of the coils of the spring while retaining good cohesion of the spring, the coating has a thickness at least equal to a quarter of the width of a fiber of said fibers. Preferably, the process comprises a step of polishing the coating so as to remove the imperfections of the coating 3 and to control the thickness of the coating. The polishing is preferably carried out so as to leave the coating with a thickness of between 3 μm and 20 μm.

The coating makes it possible to cover the fibers present at the surface of the spring and which the process for the manufacture of the mainspring, and also the step of polishing the spring before the coating, had not made it possible to remove. This is advantageous since the fibers present at the surface of the spring tend to increase the friction between the coils. The coating makes it possible to reduce the rubbing actions of the coils of the mainspring in operation. The coating described here also makes it possible to reduce the risks of the coating breaking or delaminating, which risk can be high with a conventional metal coating. As the elasticity modulus of the composite matrix of the mainspring is much higher than that of the coating, the latter participates only in a negligible way in the mechanical properties of the coated mainspring.

### REFERENCE NUMBERS EMPLOYED IN THE FIGURES

1 mainspring

2 barrel drum

3 coating

1-24. (canceled)

25. A mainspring for a driving element for a timepiece movement, said mainspring being made of a material comprising a polymer matrix containing fibers, wherein said mainspring comprises a coating comprising a resin of epoxy type having a gel time which is greater than 20 min at 90° C.

26. The mainspring according to claim 25, wherein said thermosetting polymer of said polymer matrix comprises a resin of epoxy type.

27. The mainspring according to claim 25, wherein the fraction by volume of fibers in the polymer matrix is between 30% and 75% and preferably between 45% and 55%.

28. The mainspring according to claim 25, wherein the fibers are oriented unidirectionally in the polymer matrix.

29. The mainspring according to claim 25, wherein the fibers have an axial elasticity modulus of between 80 GPa and 600 GPa.

30. The mainspring according to claim 25, wherein the fibers comprise type S or type S2 glass fibers.

31. The mainspring according to claim 25, wherein the angle between the axis of each fiber and the axis of the spring is between 0° and 5°.

32. The mainspring according to claim 25, wherein the fibers have a diameter of between 1 μm and 35 μm.

33. The mainspring according to claim 25, wherein the matrix additionally comprises nanoparticles.

34. The mainspring according to claim 33, wherein said nanoparticles comprise silica or fullerenes.

35. The mainspring according to claim 25, wherein the coating has a thickness of between 3 μm and 20 μm.

36. A driving element for a timepiece movement comprising a mainspring being made of a material comprising a polymer matrix containing fibers, said mainspring comprising a coating containing a resin of epoxy type having a gel time which is greater than 20 min at 90° C.

37. A timepiece comprising a driving element comprising a mainspring being made of a material comprising a polymer matrix containing fibers, said mainspring comprising a coating containing a resin of epoxy type having a gel time which is greater than 20 min at 90° C.

38. A process for producing a mainspring being made of a material comprising a polymer matrix containing fibers, said mainspring comprising a coating containing a resin of epoxy type having a gel time which is greater than 20 min at 90° C., the process comprising:
providing the mainspring made of a material comprising a polymer matrix comprising fibers;
coating the mainspring with a composition comprising a polymer;
homogenizing the thickness of the composition coating the mainspring; and
polymerizing the composition in order to form the coating.

39. The process according to claim 38, wherein the homogenization step comprises the rotation of the mainspring coated with the composition along axes of rotation oriented in the three orthogonal dimensions X, Y and Z.

40. The process according to claim 38, wherein the homogenization step comprises the rotation of the mainspring coated with the composition along an axis of rotation oriented with an angle of between 10° and 80° from the plane of winding of the mainspring.

41. The process according to claim 38, wherein the step of polymerization of the composition comprises the heating of the mainspring coated with the composition.

42. The process according to claim 38, wherein coating the mainspring comprises a step of immersion of the spring in the composition, or a step of spray coating, or a step of vapor-phase deposition.

43. The process according to claim 38, further comprising a step of polishing the coating so as to leave the coating with a thickness at least equal to a quarter of the width of a fiber of said fibers.

44. The process according to claim 43, the polishing step leaves the coating with a thickness of between 3 μm and 20 μm.
